(19) United States
(12) Patent Application Publication
(10) Pub. No.: US 2010/0263472 A1
(43) Pub. Date: Oct. 21, 2010

(54) LINEAR AXLE

(75) Inventors: DIETER PALM, Werther (DE); Bernd Heinzel, Porta Westfalica (DE); Raimund Malek, Auetal 2 (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: RK Rose + Krieger GmbH Verbindungs-und Positioniersysteme, Minden (DE)

(21) Appl. No.: 12/760,100

(22) Filed: Apr. 14, 2010

(30) Foreign Application Priority Data
Apr. 17, 2009 (DE) 20 2009 002 076.2
Sep. 14, 2009 (DE) 20 2009 012 485.1

(51) Int. Cl. B61H 7/00; G05G 7/00

(52) U.S. Cl. 74/490.09; 188/41

(57) ABSTRACT

A linear axle includes at least one vertical guide rail, a guide block having a housing and being movable along the at least one guide rail, at least one brake wedge associated with each guide rail and being movable in a longitudinal direction of the respective guide rail, a linear drive moving the at least one brake wedge into an out-of-operation position during normal operation, and a mechanical energy storing device configured to move the at least one brake wedge into an effective position, if the linear drive becomes ineffective during a service interruption. In an alternative embodiment, the guide block associated with a linear axle of the aforedescribed type may be stationary, whereas the respective guide rail may be movable along its longitudinal direction.

### CROSS-REFERENCES TO RELATED APPLICATIONS

This application claims the priority of German Patent Applications, Serial Nos. 20 2009 002 076.2, filed Apr. 17, 2009, and 20 2009 012 485.1, filed Sep. 14, 2009 pursuant to 35 U.S.C. 119(a)-(d), the contents of which are incorporated herein by reference in its entirety as if fully set forth herein.

### BACKGROUND OF THE INVENTION

The present invention relates, in general, to a linear axle, and more particularly to a linear axle with at least one vertical guide rail and a guide block which has a housing and is movable along the guide rail or guide rails by a drive.

The following discussion of related art is provided to assist the reader in understanding the advantages of the invention, and is not to be construed as an admission that this related art is prior art to this invention.

Linear axles are employed in automation systems. Typically, such linear axles are equipped with guide blocks which move along a three-dimensional coordinate system. Problematic with such linear axles is movement along the so-called Z-axis, which is defined by the vertical guide rail or the vertical guide rails. If the linear axles are equipped with more than one guide rail, these guide rails extend along mutually parallel axes.

Any component proven in drive technology can be used for driving the guide blocks. Regardless of the type of drive, these drives must be constructed so that the guide block is held at any position independently and redundantly by the motor brake.

It is customary to additionally secure the guide block during maintenance, for example via separate support in form of an auxiliary device or interfering structures outside the linear axle, for example a support. However, these measures make handling quite cumbersome and are inadequate to satisfy safety requirements. In the event of a service interruption, for example due to a power outage, the guide block moves brakeless along the guide rail(s) forming the Z-axis. This creates a correspondingly high risk for injury.

It would therefore be desirable and advantageous to address this problem and to obviate other prior art shortcomings by providing an improved linear axle wherein in normal operation, the guide block carrying the load can move freely, whereas in the event of a service interruption, for example during maintenance or repair work or the like, for example caused by the power outage, the guide block can still be moved with braking, but may then optionally also remain in a stationary position after a relatively short stopping distance.

### SUMMARY OF THE INVENTION

According to one aspect of the present invention, a linear axle includes at least one vertical guide rail, a guide block having a housing and being movable along the at least one guide rail, at least one brake wedge associated with each guide rail and being movable in a longitudinal direction of the respective guide rail, a linear drive moving the at least one brake wedge into an out-of-operation position during normal operation, and a mechanical energy storing device configured to move the at least one brake wedge into an effective position, if the linear drive becomes ineffective during a service interruption.

In an alternative embodiment, a guide block associated with a linear axle of the aforedescribed type may be stationary, whereas the respective guide rail may be movable along its longitudinal direction.

With the present invention, at least one brake wedge, which is movable in the longitudinal direction of the guide rail, is associated with each guide rail, that in normal operation each brake wedge is moved by a linear drive into an out-of-operation position, and that in the event of a service interruption, the linear drive is ineffective and the brake wedge can be moved into the effective position by way of a mechanical energy storing device.

Normal operation is to be understood that the guide block can be controllably moved along the vertical guide rail or along the vertical guide rails, whereas in the event of a service interruption the guide block is either moved under braking or remains at its position. The brake wedge could then also be referred to as a retaining wedge, which provides a reliable safety measure against unintentional lowering, which is independent and redundant of the motor brake of the drive for the guide block.

The linear drive has the advantage that it is activated in normal operation and holds the brake wedge in the ineffective position, while if a service interruption or a defect occurs, the mechanical energy storing device moves the brake wedge into the effective position or the braking or retaining position. The mechanical energy storing device therefore operates independently from the drive for the guide block or of the electric power supply. The electric current to the system having the linear axle is interrupted by a main switch during required maintenance on the linear axle. In this case, the linear drive is also the ineffective, so that the mechanical energy storing device can relax, driving the associated retaining wedge into the effective position.

All linear drives can be constructed of conventional construction known in drive technology. However, currently preferred is the provision of a piston-cylinder unit, advantageously implemented as a pneumatic cylinder. However, electric cylinders as well as hydraulic piston cylinder units and the like can also be used.

According to another advantageous feature of the present invention, the functionality of the linear axle can be enhanced if the force applied in normal operation by each linear drive on the brake wedge is greater than the force to be generated by the energy storing device. In normal operation, the force applied by each linear drive on the brake wedge can be viewed as a continuous force.

According to another advantageous feature of the present invention, the linear axle may be provided with a single guide rail or with two mutually parallel, spaced-apart guide rails. To attain force equilibrium when the retaining wedge is moved into the effective position by the mechanical energy storing device during a service interruption, two opposing brake wedges may be associated with at least one guide rail.

To minimize the parts count, a corresponding beveled face facing each guide rail may be provided on both sides of the housing, wherein the beveled face interacts with the wedge face of the brake wedge. When the brake wedge is moved by the energy storing device, the face facing the beveled face then makes contact with the guide rail over the entire length. In a modified embodiment, a roller guide composed of several spaced-apart rollers or needles is arranged between the beveled faces of the housing of the guide block and the beveled faces of the brake wedges. A kind of linear roller bearing is formed in this way which ensures that each brake wedge can be moved by the relaxing mechanical energy storing device with minimized friction forces, so that the linear drive can be operated with minimal axial forces. This construction also produces a relatively large braking and retaining force due to the relatively large difference between the rolling friction and the dynamic and static friction at the contact faces between the guide rail and the brake lining. Advantageously, the brake wedges retain their full effect even when the contacting faces are provided with a lubricant layer.

According to another advantageous feature of the present invention, each brake wedge may include a socket and a brake lining. The socket may face the associated beveled face of the housing of the guide block, while the brake lining is disposed on the side facing the guide rail. The brake lining can be made of a conventional material with a corresponding friction coefficient. The brake lining can be inserted in a recess formed in the socket to prevent detachment of the brake lining from the socket even when subjected to relatively large forces.

Because the forces applied to the guide block are different depending on the application, or can change depending on the application, the thrust force applied by the energy storing device onto the brake wedge may be adjustable. This adjustment also affects the friction forces between the guide rail and the brake lining. In a preferred embodiment, the energy storing device is a compression spring or a gas spring. This is achieved, for example, by a greater prestress of the energy storing device. If the energy storing device in the preferred embodiment is a compression spring, then the prestress is adjusted with adjustment screws. In this embodiment, additional damping rings are provided between the associated face of the housing and the screw heads.

To facilitate installation of the brake wedges, guide pins for fixing the position of each brake wedge can be inserted in the housing of the linear axle. Advantageously, two spaced-apart guide pins are provided for each brake wedge. These guide pins are oriented perpendicular to the slide faces of the brake wedges.

The wedge angle of the brake wedge may be less than 5°.

According to another advantageous feature of the present invention, at least two guide blocks may be placed on each guide rail. The braking forces generated by the brake wedges can thereby be increased commensurate with the number of guide blocks. If each guide block is provided with two brake wedges, then the number of brake wedges is twice the number of guide blocks. However, it may be understood that the braking forces do not double when using two guide blocks and do not triple when using three guide blocks.

According to another advantageous feature of the present invention, the number of guide blocks can be an even number. The consecutively arranged guide blocks can advantageously be arranged mirror-symmetric to one another. If two guide blocks are placed on the guide rail, the braking effect of the guide blocks can advantageously be effective in both directions of the guide blocks, i.e., the braking effect can be generated both when lowering as well as when raising the guide blocks.

Advantageously, for example when two guide blocks are placed on the guide rail mirror-symmetrically, the brake wedges of one guide block can be moved into the out-of-operation position and the brake wedges of the other guide block can be moved into the effective position during a service interruption.

According to another advantageous feature of the present invention, the housing of each guide block may have a U-shaped cross-section. The housing may be provided on one side with a slotted opening, allowing inspection of the housing from this side. The linear axle may also include a drive configured to move the guide block.

In addition, the travel of each brake wedge can be adjusted with at least one adjustment screw. These adjustment screws face the energy storing devices, so that the braking or retaining force generated by the energy storing devices can be adjusted commensurate with the particular requirements.

According to another advantageous feature of the present invention, each guide block may be provided with a brake wedge associated with the guide rail, and the guide block may be movable perpendicular to the guide rail. Depending on the application, this simplified configuration may be sufficient to hold the load or to move the load with braking. Advantageously, a movable support element, which aids in stabilizing the guide rail, may be mounted on the side facing away from the brake wedge, so as to prevent bending of the guide rail when the brake wedge is moved into the effective position. Moreover, a housing of identical construction can be used wherein the second brake wedge is replaced by the support element.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows, in a partial view, a linear axle according to the invention showing a guide block;

FIG. 2 shows, in a half section, a detail of a braking and retaining device of the linear axle according to the invention;

FIG. 3 shows, in a partially broken view, a linear axle in a second embodiment with two guide blocks placed on a guide rail;

FIG. 4 shows a diagram according to FIG. 3, where the guide block is displaced by 180° compared to the embodiment of FIG. 3; and

FIG. 5 shows, in a partially cut view, a third embodiment of a linear axle with a single brake wedge.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

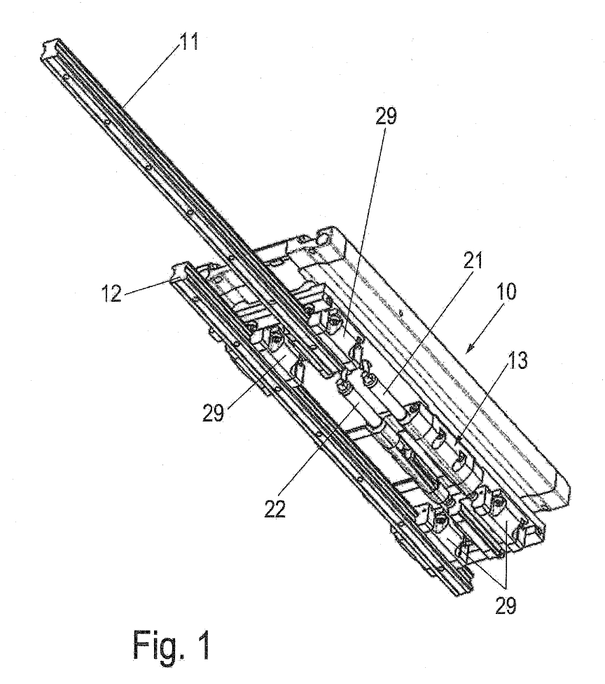

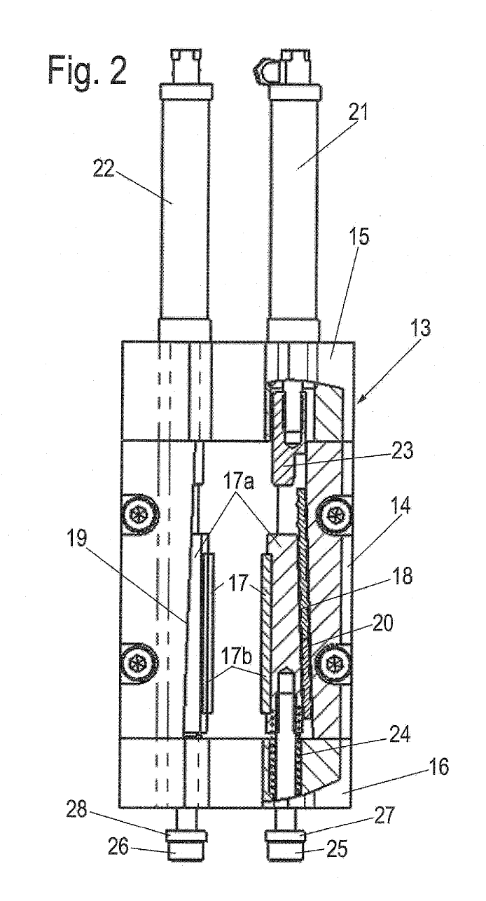

Turning now to the drawing, and in particular to FIG. 1, there is shown a guide block 10 which is movable along two mutually parallel and spaced-apart guide rails 11, 12. The complete linear axle is not shown in this simplified illustration. In the illustrated embodiment, a braking and retaining device 13 is associated with the guide rail 11, which is explained in more detail in FIG. 2. In contrast to the illustrated embodiment, a braking and retaining device 13 may be associated with the guide rail 12. In principle, several braking and retaining devices 13 may be employed.

The guide block 10 illustrated in FIG. 1 is designed so that two spaced-apart, otherwise unspecified carriages 29 are associated with each guide rail 11, 12.

The guide rail 11 associated with this braking and retaining device 13 is also not shown in this region of FIG. 2 in order to simplify the drawing. The guide block 10 is moved by a drive along the two guide rails 11, 12 in a manner which is not illustrated and described in detail. Such drive may be, for example, a toothed belt drive or a spindle drive. The guide block 10 includes a housing 14, which is closed by two opposing covers 15, 16. The housing 14 is provided with a groove-like guide for the brake wedges 17 arranged on both sides of the unillustrated guide rail. The brake wedges 17 are moved in the longitudinal direction in a manner described in more detail below. The two brake wedges 17 are provided with beveled faces 18 on the sides that face away from one another. The housing 14 also includes beveled faces 19 which are parallel and spaced from the beveled faces 18. As shown more particularly in the half section according to FIG. 2, a roller guide 20 composed of several spaced-apart needles or rollers is arranged between the two spaced-apart beveled faces 18, 19.

Each brake wedge 17 is composed of a socket 17a and a brake lining 17b. As illustrated in FIG. 2, the brake linings 17b are mutually parallel and define a gap therebetween.

The brake wedges 17 are operatively coupled to linear drives in form of pneumatic cylinders 21, 22. The piston and the piston rods, respectively, of these pneumatic cylinders 21, 22 are coupled to the brake wedges 17 via thrust members 23. The pneumatic cylinders 21, 22 are located at the front, as seen in the upward direction of the guide block 10. On the opposing side, an energy storing device implemented as a compression spring 24, or alternatively a gas spring, acts on each brake wedge 17. Each compression spring 24 can also be tensioned or relaxed with an adjustment screw 25, 26 in order to generate different prestress. Damping rings 27, 28, which prevent a sudden impact of the heads of the adjustment screws 25, 26, are arranged between the end face of the cover 16 and the heads of the adjustment screws 25, 26.

During normal operation, i.e., when the system equipped with the linear axle is operating, pressure is applied to the pneumatic cylinders 21, 22. The pressure is set so as to move the brake wedges 17 towards the compression springs 24, because the forces generated by the pneumatic cylinders 21, 22 are greater than the forces of the prestressed compression springs 24. The brake wedges 17 are ineffective in this position. However, if electric power to the system is interrupted, the pneumatic cylinders instantaneously lose pressure. The compression springs 24 then relax and move the brake wedges 17 towards the pneumatic cylinders 21, 22.

FIG. 2 shows clearly that the brake wedges 17 are moved towards one another in the radial direction and that they thereafter make contact with the respective guide rail 11, 12. FIG. 2 also shows that the bevel angles of the beveled faces of the brake wedges 17 and the housing 10 are relatively small, generating a substantial braking and retaining force. The tension of the compression springs 24 can be adjusted by way of the adjustment screws 25, 26 so that the brake wedges 17 are pressed against the guide rail 11 and 12, respectively, only with a force sufficient to enable braked travel of the guide block 10. In addition, the adjustment can be selected so that the guide block comes to a stop after having traveled a minimum distance. The retaining forces generated by the brake wedges 17 are then large enough to maintain the position of the guide block 10. The linear axle is referred to in the industry as linear unit.

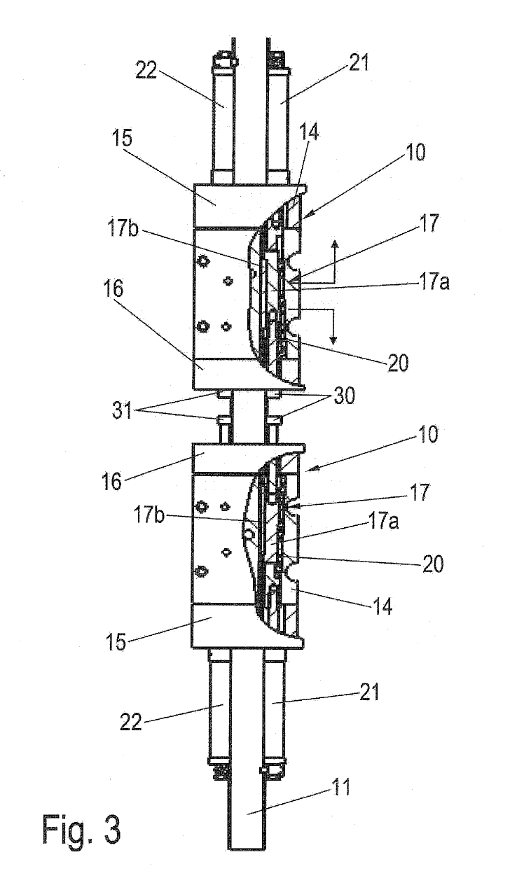

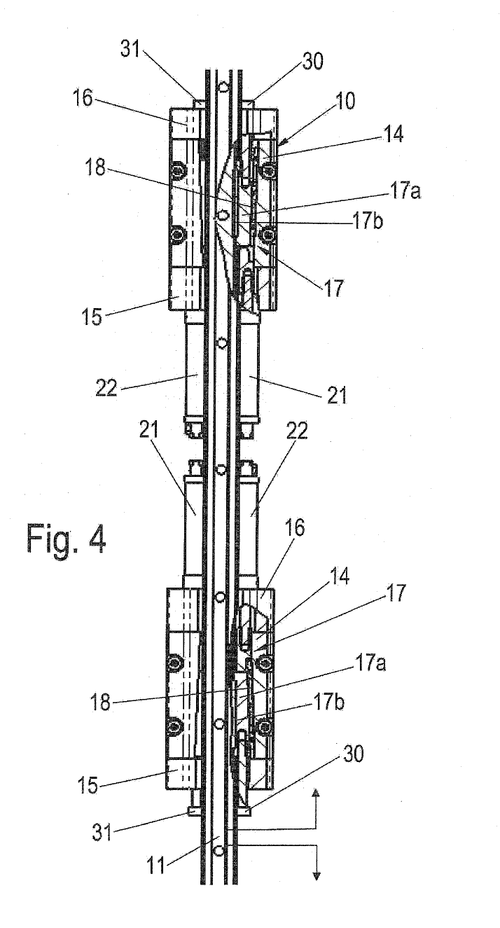

FIGS. 3 and 4 show an embodiment where two mirror-symmetrically arranged guide blocks 10 are placed on a single guide rail 11.

The embodiment of FIGS. 3 and 4 corresponds essentially to the embodiment of FIG. 2, with the difference that thrust members operating on the brake wedges 17 are placed on the piston rods of the linear drives 21, 22. In addition, adjustment screws 30, 31 for adjusting or setting the travel of each brake wedge 17 are provided in the areas containing the energy storing device 24. In the embodiment of FIG. 3, the linear drives 21, 22 are located on the sides facing away from one another, but are arranged mirror-symmetrically, as shown in FIG. 3.

In the embodiment of FIG. 4, the guide blocks 10 have the same design as the guide blocks of FIG. 3. However, these guide blocks 10 are once more arranged mirror-symmetrically, with the linear drives 21, 22 being arranged on the sides facing one another, so that the adjustment screws 30, 31 are located on the sides facing away from one another.

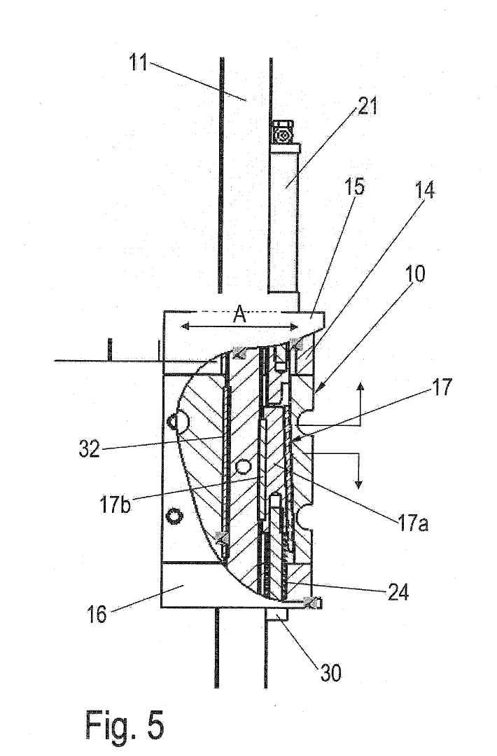

In the embodiment of FIG. 5, the linear axle is equipped with a guide block 10 which has only a single brake wedge 17 located on one side of the guide rail. On the opposite side, a support element 32, which may be a floating caliper, is associated with the guide rail 11. Different from the illustrated embodiment, several consecutively arranged guide blocks 10 may also be placed on the guide rail 11, wherein two consecutive guide blocks 10 can once more be arranged with mirror-symmetry. In this embodiment, the guide block 10 moves away from the guide rail 11 when the brake wedge 17 is moved into the effective position, whereas the guide block 10 moves in the opposite direction, i.e., towards the guide rail, wherein the brake wedge 17 is moved into the release position, as indicated by the double arrow A.

In contrast to the aforedescribed embodiments, where each guide rail 11, 12 is stationary and the guide block 10 is moved in the longitudinal direction, in a reverse configuration, the guide rail 11 may be moved while the guide block/blocks 10 remains/remain stationary.

The invention is not limited to the illustrated embodiment. It is only important that at least one brake wedge 17 is associated with each guide rail 11, 12, wherein preferably a corresponding brake wedge 17 is arranged on each side of the guide rail 11, 12. In normal operation of a system equipped with the linear axle, each brake wedge 17 is positioned with the linear drive in form of a pneumatic cylinder 21, 22 so that the brake wedges become ineffective. However, during a service interruption, the compression springs 24 relax and the brake wedges 17 contact the respective guide rail 11, 12.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A linear axle, comprising:
at least one vertical guide rail;
a guide block having a housing and being movable along the at least one guide rail;
at least one brake wedge associated with each guide rail and being movable in a longitudinal direction of the respective guide rail;
a linear drive moving the at least one brake wedge into an out-of-operation position during normal operation; and
a mechanical energy storing device configured to move the at least one brake wedge into an effective position, if the linear drive becomes ineffective during a service interruption.

2. The linear axle of claim 1, wherein a force applied by the linear drive on the at least one brake wedge during normal operation is greater than a force produced by the mechanical energy storing device.

3. The linear axle of claim 1, further comprising two opposing brake wedges which are associated with at least one guide rail.

4. The linear axle of claim 1, wherein the housing of the guide block is provided with beveled faces which correspond to wedge faces of the at least one brake wedge.

5. The linear axle of claim 4, further comprising a roller guide formed of several spaced-apart rollers or needles and disposed between a beveled face of the housing and an opposing wedge face of the brake wedge.

6. The linear axle of claim 1, wherein the at least one brake wedge comprises a socket and a brake lining.

7. The linear axle of claim 6, wherein the brake lining is inserted in a recess of the socket.

8. The linear axle of claim 2, wherein the force applied by the mechanical energy storing device on the associated brake wedge is adjustable.

9. The linear axle of claim 8, further comprising adjustment screws for adjusting the force applied by the mechanical energy storing device on the associated brake wedge.

10. The linear axle of claim 9, further comprising a damping ring disposed between a head of an adjustments screw and an opposing face of the housing.

11. The linear axle of claim 1, wherein the housing comprises guide pins for fixing a position of the at least one each brake wedge.

12. The linear axle of claim 1, wherein the at least one brake wedge is configured as a retaining wedge.

13. The linear axle of claim 1, wherein a wedge angle of the at least one brake wedge is less than 5°.

14. The linear axle of claim 1, comprising at least two guide blocks which are consecutively arranged on the at least one guide rail.

15. The linear axle of claim 14, wherein the at least two guide blocks have a mirror-symmetric configuration and are arranged alternatingly on the at least one guide rail.

16. The linear axle of claim 15, wherein in the event of a service interruption, the brake wedge of one of the at least two guide blocks is moved into the out-of-operation position, whereas the brake wedge of another of the at least two guide blocks is moved into the effective position.

17. The linear axle of claim 1, wherein each guide block is provided with a brake wedge, with the guide block being movable perpendicular to the guide rail.

18. The linear axle of claim 17, further comprising a movable support element disposed on a side of the at least one guide rail facing away from the at least one brake wedge.

19. The linear axle of claim 1, wherein the housing has a U-shaped cross-section.

20. The linear axle of claim 1, further comprising at least one adjustment screw for adjusting travel of the at least one brake wedge.

21. The linear axle of claim 1, further comprising a drive configured to move the guide block.

22. A linear axle, comprising:
at least one vertical guide rail movable in a longitudinal direction;
a stationary guide block having a housing;
at least one brake wedge associated with each guide rail and being movable in a longitudinal direction of the respective guide rail;
a linear drive moving the at least one brake wedge into an out-of-operation position during normal operation; and
a mechanical energy storing device configured to move the at least one brake wedge into an effective position, if the linear drive becomes ineffective during a service interruption.
